(19) United States
(12) Patent Application Publication
(10) Pub. No.: US 2009/0216375 A1
(43) Pub. Date: Aug. 27, 2009

(54) Industrial Robot Tending A Machine And A Method For Controlling An Industrial Robot Tending A Machine

(76) Inventor: Raoul Audibert, Vasteras (SE)

Correspondence Address: ST. ONGE STEWARD JOHNSTON & REENS, LLC, 986 BEDFORD STREET, STAMFORD, CT, 06905-5619, US

(21) Appl. No.: 12/437,078

(22) Filed: May 7, 2009

(30) Foreign Application Priority Data
Oct. 19, 2007 (EP) PCT/EP2007/061212

(51) Int. Cl. G05B 19/418

(52) U.S. Cl. 700/262

(57) ABSTRACT

An industrial robot for tending a machine includes a machine part providing a repetitive sequence of movements. The robot includes a robot controller having a program storage for storing a path of programmed positions for the robot and a path of programmed positions for the machine part, and a motion planner configured to plan the motion of the robot and the motion of the machine part based on the programmed positions for the robot and the machine part such that the motion of the robot and the motion of the machine part are coordinated with each other.

### CROSS-REFERENCE TO RELATED APPLICATIONS

The present application is a continuation of pending International patent application PCT/EP2007/061212 filed on Oct. 19, 2007 which designates the United States, the content of which is incorporated herein by reference.

### FIELD OF THE INVENTION

The present invention relates to an industrial robot for tending a machine including a machine part providing a repetitive sequence of movements. The present invention also relates and to a method for tending such a machine.

The present invention is suitable for any type of industrial process, which makes use of a machine that is tended by a robot, and the robot motion has to be coordinated with the motion of a movable part of the machine in order to avoid collisions between the robot and the machine part. Suitable processes are, for example, die casting, injection molding, and other types of metal forming and plastic machinery, loading and unloading of milling machines, lathes, grinding equipment, and arc welding.

### BACKGROUND OF THE INVENTION

In many industrial applications an industrial robot is used for tending a machine, for example to remove products produced by the machine. Such an application is injection molding, which uses robots to remove molded products from the molding machine. To avoid collisions with the machine, the movements of the robot, such as gripping and release of the product from the machine, must be coordinated with movements of moving parts of the machine. For example, if the machine is an injection-molding machine the moving part is a mold part that opens and closes the mold.

The key in making an effective product removing system is to keep the machine working all the time. No time is to be lost for the machine waiting for the robot. The problem that is faced is that once the robot has taken a part from the machine, the robot shall extract the part and itself from the machine at the same time that the machine is closing. This is critical for minimizing the overall machine cycle time. The problem is compounded in the fact that the machine is typically hydraulic and the closure is fast and not controlled by the robot controller. It is normally very difficult to teach the robot motion and very hard to predict if the robot can extract the part without the mold hitting the robot during closure. The robot may have been programmed to perform a complex reorientation during the extraction and this will slow down the robot allowing the mold to catch up and hit the robot.

Generally, this synchronization between robot and mold is currently achieved by signals provided by the machine and sent to the robot control system. For example, the molding machine sends a signal to the robot when the protective door has been opened and when the mold is opened, and a signal is sent from the robot to the injection-molding machine when the robot has finished removing the product. Upon receipt of this product removal finish signal, the injection-molding machine starts the next molding operation. In this general method for removing a molded product, the robot starts its operation after waiting until the mold has opened completely, and the injection molding machine starts the mold closing operation for the next molding cycle after waiting until the product removing unit has removed the molded product completely. Therefore the waiting time consumes valuable time, and the cycle time of molding is prolonged.

A solution to this problem is proposed in US patent application No. 2004/0005372. This document describes a controller for avoiding interference between a mold body and a product removing unit, such as a robot, in an injection-molding machine. The distance between the mold body and the robot is determined. Then it is judged whether or not the distance between the mold body and the robot is smaller than a predetermined distance. If the distance is smaller than a given safety distance, the machine is told to slow down or stop. This controller makes it possible to reduce the margins in time and spacious separation between the robot and the molding machine and thereby to reduce the cycle time. The problem with this solution is that the calculation of the distance is complex and there are many points on the robot and the robot tool that could possibly collide with the closing mold.

Another solution to this problem is proposed in the international patent application no. PCT/EP2006/068855. This document discloses an industrial system comprising a machine for processing a product, the machine including a actuator providing a repetitive sequence of movements of a machine part, and a regulator controlling the movements of the actuator in response to a reference value, and an industrial robot adapted to tend the machine, such as to remove the product from the machine. The robot includes a robot controller comprising a program storage for storing control programs including movement instructions for the robot and for the machine part, and a motion planner adapted to determine how the robot should move in order to be able to execute the movement instructions for the robot and on the basis thereon generate control signals to a robot drive unit. The motion planner is further adapted to determine how the machine part should move in order to be able to execute the movement instructions for the machine part and on the basis thereon generate reference values to the actuator. The robot controller is so adapted to control both the robot and the machine. Since the movements of the movable machine part are controlled from the same controller as the robot movements, it is possible to coordinate the motion of the robot and the machine, and thereby optimization of the cycle time will become much simpler and there is a potential for substantial reduction of cycle time.

However, for some machine parts, in particular if the actuator actuating the machine part is hydraulic, the control of the motion of the mold part is quite complicated, and therefore the robot controller is not suitable for controlling the machine part. In addition, there may also be more complex motions and forces involved where a dedicated controller is optimal for the machine. Thus a robot controller does not have functions and capacity to perform all necessary calculations for mold control. In those cases it is desired to have a separate machine controller controlling the motion of the machine part.

### SUMMARY OF THE INVENTION

The object of the present invention is to provide an attractive solution to the above-mentioned problems, and to provide an easy programming of the tending process with the robot and the machine.

According to one aspect of the invention this object is achieved by an industrial robot as defined in claim 1.

Such an industrial robot includes a robot controller comprising a program storage for storing a path of programmed positions for the robot and a path of programmed positions for the machine part, and a motion planner configured to plan the motion of the robot and the motion of the machine part based on the programmed positions for the robot and the machine part such that the motion of the robot and the motion of the machine part are coordinated with each other. The invention is characterized in that the motion planner is configured to calculate expected positions of the machine part along the path based on the planned motion of the machine part, and the robot controller is configured to receive information on actual positions of the machine part, to compare the actual positions with the expected positions of the machine part, and to generate a signal to slow down or stop the motion of the machine part when the actual position is ahead of the expected position of the machine part.

In order to minimize the cycle time, the motion of the robot and the motion of the machine part are coordinated with each other. This coordination means that the robot motions as well as the machine motions are planned with regard to performance limitations of the robot and optionally also with regard to performance limitations of the machine.

Although the robot controller plans the movement path of the machine part, the robot controller does not control the motion of the machine part. The planning of the actual motion of the machine part and the generation of control signals to the machine part is done in a separate machine controller. Thus, the invention makes it possible to coordinate the robot motion with the motion of the machine part, thereby reducing the cycle time, at the same time as the actual control of the motion of the machine is carried out by a separate machine controller, thereby achieving an accurate control of the motion of the machine part.

The path of the machine part calculated in the robot controller is planned based on a plurality of programmed positions on the machine path and a plurality of corresponding programmed positions on the robot path. By corresponding is meant that the positions have a known relation to each other, such as when the robot is positioned in a programmed position on the robot path, the machine part must be positioned in the corresponding programmed position on the machine path, or the machine part must be positioned in a position behind the corresponding programmed position on the machine path. This information is used to coordinate the robot motion and the motion of the machine part. The motion of the machine part can either be linear or along a curve and may contain one or more axes.

The purpose for planning the motion of the machine part in the robot controller is to use the planned machine path for planning a robot motion that is coordinated with the motion of the machine part. As the planned motion of the machine part is not to be used for controlling the actual motion of the machine part, the planning of the machine path carried out by the robot controller can be simplified. However, the actual path for the machine part, which is planned in the separate machine controller, is not coordinated with the robot. In order to avoid collisions between the robot and the machine part, during the motion, expected positions of the machine part, calculated based on the machine path planned by the robot controller, are repeatedly compared with actual positions of the machine part, and a signal to slow down or stop the machine part is generated when the actual position is ahead of the expected position of the machine part.

This present invention has significant improvements over existing methods in that it allows easy programming and a simpler and more reliable method to prevent the robot from colliding with the machine during the tending. Only a single position/speed signal is needed from the machine controller to the robot controller. This will save costs.

The machine can be typically a plastic Injection Molding Machine, Die Casting Machine, press machine, or other equipment containing a cyclic operation with a form. The machine can also be an ejector device, where a part is ejected from a machine. In addition, the invention applies to machines that close or eject along a curve, or machines that may have several axes that are closing/ejecting.

In some cases, the robot motion is the limiting factor with regard to the cycle time. An example of such a case is a robot extracting molded parts from a mold, and the motion of the mold is opening and closing of the mold.

According to an embodiment of the invention, the motion planner is configured to plan the motion of the robot and the motion of the machine part based on performance capabilities of the robot and of the machine, and the performance capabilities for the machine are set to be much higher than for the robot so that the motion planner uses the limitations of the robot when planning the motion of the machine. For example, the performance capabilities of the machine can be set to limitless and the performance capabilities of the robot are set to the true performance capabilities of the robot. The performance capabilities can be, but are not limited to, for example, maximum velocity, maximum acceleration, maximum torque per current number of revolutions, and cross torque from other axes. In order to minimize the cycle time, the motion of the machine part is coordinated with the motion of the robot. According to this embodiment, the robot motions as well as the machine motions are planned only with regard to performance limitations of the robot, and not with regard to performance limitations of the machine. It is assumed that the machine has no performance limitations. Thus, a close-to-optimal path for the robot is planned and accordingly a close-to-optimal cycle time is achieved. If this assumption is wrong for a part of the path, the real machine will move ahead of the planned path and the signal to slow down or stop the machine is generated.

According to an embodiment of the invention, the robot controller further is configured to generate a signal to speed up the motion of the machine part when the actual position of the machine part is behind the expected positions of the machine part. This embodiment further reduces the cycle time.

According to an embodiment of the invention, the motion planner is configured to plan the motion of the robot and the machine part in incremental steps, and to calculate the expected position of the machine part for each incremental step, and the robot controller is configured, for each incremental step, to compare the actual position of the machine part with the expected position. As the motion planner plans the motion of the robot and the machine part in incremental steps, it is suitable to compare the actual position of the machine part with the expected position and generate the signal for slowing down or stop the motion of the machine part each incremental steps. Further, a high accuracy is achieved.

According to an embodiment of the invention, the path planner is configured to generate set point values for the robot motion and set point values for the expected motion of the machine part and the set point values of the machine part contain the expected position of the machine part. Typically, a robot planner is configured to generate set point values for the robot motion including, inter alia, position and velocity. By using the set point values no extra calculations are needed.

According to an embodiment of the invention, at least two of said programmed positions for the robot correspond in time to at least two of said programmed positions for the machine part. This means that the robot must be positioned in a programmed position on the robot path at the same point in time as the machine part is positioned in the corresponding programmed position on the machine path. Knowing the positions corresponding in time for the robot and for the machine part facilitates the coordination of the robot motion and the motion of the machine part.

According to an embodiment of the invention, said program storage is configured to store a control program including movement instructions for the robot and the machine part and the control program includes a plurality of positions on the robot path and a plurality of corresponding positions on the machine part path, and the robot controller further comprises a program executor adapted, during execution of the control program, to extract said corresponding positions on the robot path and the machine path, and to send the positions to the motion planner. It is convenient for the robot programmer to supply the programmed position on the machine path in the same way as the programmed positions on the robot path. The program executor extracts the positions on the machine path during execution of the control program in the same way as it extracts the positions on the robot path, and sends the positions to the motion planner. Thus, a traditional program executor can be used for supplying the positions of the machine path to the path planner.

The invention is particularly suitable for an application in which the robot is configured to extract a part from the machine when the movement of the machine part is closing the machine.

According to another aspect of the invention this object is achieved by a method as defined in claim 8.

Such a method comprises: storing a path of programmed positions for the robot and a path of programmed positions for the machine part, planning the motion of the robot and the motion of the machine part based on the programmed positions for the robot and the machine part such that the motion of the robot and the motion of the machine part are coordinated with each other, calculating an expected position for the machine part based on the planned motion of the machine part, receiving information on the actual position of the machine part, comparing the actual position of the machine part with the expected position, and generating a signal to slow down or stop the motion of the machine part if the actual position is ahead of the expected position of the machine part.

According to an embodiment of the invention, the method comprises recording a typical motion of the machine part and creating the programmed positions for the machine part based on the recorded motion.

According to a further aspect of the invention, the object is achieved by a computer program product directly loadable into the internal memory of a robot controller including a processor, comprising software code portions for performing the steps of the method according to the appended set of method claims, when the program is run on the robot controller.

According to another aspect of the invention, the object is achieved by a computer readable medium having a program recorded thereon, when the program is to make a robot controller perform the steps of the method according to the appended set of method claims, and the program is run on the robot controller.

### BRIEF DESCRIPTION OF THE DRAWINGS

The invention will now be explained more closely by the description of different embodiments of the invention and with reference to the appended figures.

FIG. 1 shows an industrial robot tending a machine according to an embodiment of the invention.

FIG. 2 shows an example of a robot control program including program positions for the robot and the machine.

FIG. 3 shows a block diagram of a robot controller for an industrial robot according to an embodiment of the invention.

FIG. 4 shows a flow diagram of an example of a method according to the invention

### DETAILED DESCRIPTION OF THE INVENTION

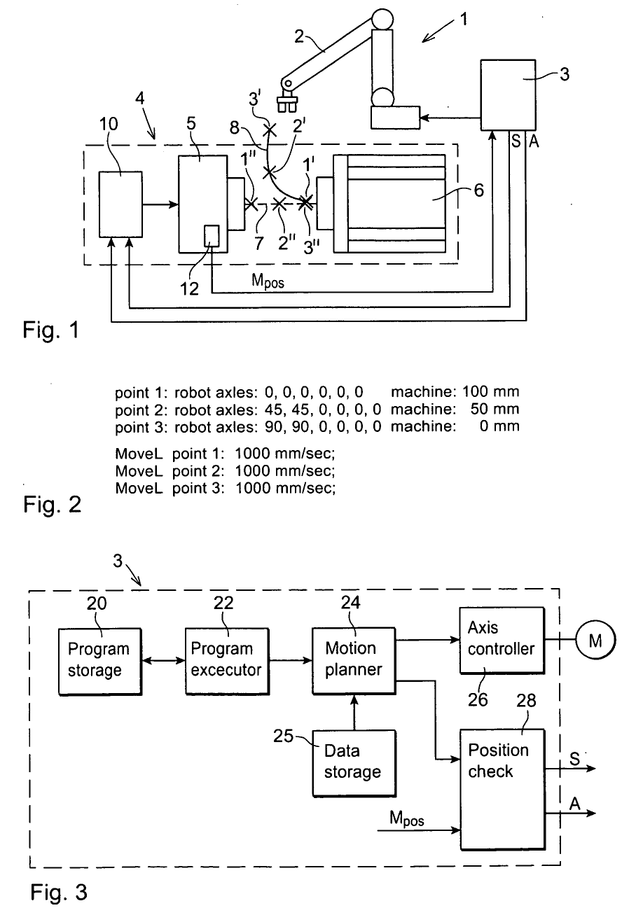

FIG. 1 shows an industrial robot 1 tending a machine 4 according to an embodiment of the invention. The industrial robot 1 includes a manipulator 2 movable about a plurality of axes and a robot controller 3 controlling the movements of the manipulator 2. The manipulator 2 includes a plurality of robot joints joined with each other so that they are rotatable or translatable relative to each other about a plurality of the axes. The robot 1 is provided with a tool, for example a gripper, adapted to pick the molded object from the machine 4 and to move it to another place for further processing. The tending of the machine may also include moving a workpiece to the machine and loading the machine with the workpiece. The manipulator includes a plurality of motors actuating the movements of the robot arms. The robot controller 3 includes an axis controller adapted to control signals, such as desired motor torques, to motors located in the manipulator 2. The control signals are generated based on control programs including movement instructions for the robot. The robot controller includes software so well as hardware, such as input and output means, a processor unit including one or more central processing units (CPU) for handling main functions of the robot controller such as executing robot control programs, performing path planning, providing orders to the axis controller.

The machine 4 includes a stationary machine part 6 and a movable machine part 5 providing a repetitive sequence of movements in relation to the stationary part 6. In this example the machine is an injection molding machine and the robot is adapted to remove a molded object from the mold at the same time as the mold is closed. By a sequence of movements is understood a defined sequence of movements, for example opening and closing of a mold, opening and closing of a protective door, ejecting and returning of ejection pins, raising and lowering a tool, such as a drill, and opening and closing of a scrap press. The defined sequence of movements is repeated each cycle. The tending of the machine includes removing the finished product from the machine. The tending of the machine may also include providing the machine with workpieces and inserts.

The machine further includes a measuring device 12 arranged to measure the position and/or speed of the movable part 5 and to provide the robot controller with the information about the actual position and/or speed of the movable machine part 5. The machine 4 further comprises a machine controller 10 adapted to generate control signals including set point values to the machine, and in particular control signals for opening and closing the mold. The movable machine part 5 includes an actuator, such as a motor, actuating the movements of the movable part and a regulator regulating the movements of the actuator, and thereby the movements of the movable part in response to set point values from the machine controller 10.

The machine is also provided with a sensor 12, sensing the actual position of the movable part 5, for example, the distance between the movable part and the stationary part 6. In an alternative embodiment, the sensor is adapted to measure the speed of the movable part 5. The output signal from the sensor 12 is sent to the robot controller 3. The robot controller 3 is configured to generate a signal S instructing the machine controller to slow down the motion of the movable machine part 5 or to stop the motion. Optionally, robot controller 3 is further configured to generate a signal A instructing the machine controller to accelerate the motion of the movable part 5, or to start the motion.

The movable machine part 5 moves along a path 7. In this example the path is linear, and the tool of the robot moves along a path 8. In the following, the path along which the machine part is moving is called the machine path 7, and the path along which the robot is moving is called the robot path 8. In this example, the robot path 8 includes three programmed positions 1′, 2′, 3′, and the machine path includes three programmed positions, 1″, 2″, 3″. The position 1′ of the robot path represents the position of the robot when the robot takes the molded object. The position 2′ of the robot path represents the position of the robot when it has just exited the machine. The position 3′ of the robot path represents the position of the robot when it is clear from the machine. The position 1″ of the machine path represents the position of the movable machine part when the machine is opened. The position 2″ of the machine path represents a position between the opened and closed position of the machine. The position 3″ of the machine path represents the position of the movable machine part when the machine is closed. The positions 1′, 2′, 3′, of the robot path correspond to the positions 1″, 2″, 3″ of the machine path 8.

The robot is programmed together with the machine. This means that for each programmed robot position, the position of the machine part is also programmed. A target point is in the following defined to include a robot position and a machine position. The robot positions are, for example, angular positions for the axes of the robot but may also include the Cartesian position and orientation of the tool. At least two target points shall be programmed, one in the initial extract position when the robot triggers the machine part to close, and one in the final closed position. Additional target points can be programmed if there are complex relations between the robot and the machine that must be taken into consideration. In the example shown in FIG. 1 three target points 1′1″, 2′2″, and 3′3″ are programmed. A programmed target point contains the position of the robot together with the corresponding position of the machine part. The target points are part of the robot program.

FIG. 2 shows an example of a robot program. In this case the robot includes six axes and the position of the robot is defined by the angles of the axes. As seen in the figure, each target point is defined by the angles of the robot axes and the distance between the movable and stationary machine parts. In this example, the machine is completely open when the distance between the machine parts is 100 mm. Accordingly, for each target point the angles of robot axes and the machine position is specified. The robot program includes three movement instructions, each including a programmed target point and information on how the movement shall be performed, such as the robot velocity in the target point. The angles of the robot axes can be taught by manually moving the robot along the path during the programming, or offline based on CAD data, or in any other known way.

Sometimes it is hard to actually move both the robot and the machine part to create the target points of the robot control program. In these situations it is sometimes more practical to create an estimated position of the machine part and storing this as part of the robot program for each programmed target point. For example, the machine could be left in the opened position when the robot is programmed for a plurality of target points. For each target point, an estimated machine position is calculated based upon the percentage of the Cartesian motion of the robot via the programmed target points. This estimated machine position is then saved in the robot program. Another useful alternative is to record a typical motion of the machine and save this in a profile. Then the machine positions are calculated based on the robot motion and the recorded profile. Again, the positions are saved in the robot program.

FIG. 3 shows a block diagram of a robot controller 3 of an industrial robot according to an embodiment of the invention. The robot controller 3 comprises program storage 20 for storage of one or more robot control programs comprising program instructions including movement instructions for the manipulator and/or for the moving machine part or parts. The robot controller 3 further comprises a program executor 22 adapted to run the robot control programs, and a motion planner 24 adapted to receive information from the program executor 22 and based thereon determine how the manipulator and the machine part should move in order to be able to execute the movement instructions. The motion planner 24 is adapted to perform an interpolation of the movements of the manipulator and the movable machine part. The motion planner 24 determines a robot path based on the information received from the program executor and generates set point values typically comprising, but not limited to, desired values for position, speed, and acceleration of the motors that actuate the movements of the robot axes. The motion planner 24 also determines a machine path based on the information received from the program executor, and generates set point values for the movable part, including desired values for position and/or speed of the movable part. The motion planner splits the motion into small incremental steps, which are executable in order to reach the specified velocity or time as given in the program.

The robot controller further comprises an axis controller 26 for the robot. The axis controller is connected to the manipulator 2 and provides the manipulator with control signals, such as motor references and power.

The control program is used to feed the target points and speed and possibly time information to the motion planner. The program executor is adapted, during execution of the control program, to extract the target points from the control program, and to send the target points to the motion planner. The motion planner is adapted to plan the robot path and the machine path based on the extracted points including corresponding positions on the machine path and the robot path.

The program executor 22 runs the robot control program and extracts the programmed robot positions and corresponding machine positions and sends them to the motion planner as the program is executed. The motion planner plans the robot motion based upon the target points, which includes the position of the robot axes and the position of the machine. When planning the robot motion, the motion planner uses robot performance data, which describes the performance capabilities of the robot, such as maximum velocity and maximum acceleration of the robot axes. In addition, the motion planner 24 uses machine performance data, which gives the performance capabilities of the motion of the movable machine part. The machine performance data and the robot performance data are stored in data storage 25 of the robot controller 3.

In some cases, the robot motion is the limiting factor with regard to the cycle time. In such cases, the machine performance data is typically set to a maximum performance so that the machine part is not the limiting factor in the motion. For example, the machine performance is set to be much higher than the robot so that the motion planner is in effect only using the limitations of the robot when planning the fastest motion out of the machine. The motion planner plans a motion that ensures that the robot and the machine part move to the programmed points using the maximum capacity of the robot. In other cases, the machine motion is the limiting factor. In such cases, the machine performance data is set to the actual performance capabilities of the machine. In this case the robot path is coordinated with the machine path based on the actual performance capabilities of the machine.

The output from the robot motion planner is a trajectory including position, speed and time for both the robot and the movable machine part such that the motion of the robot and a machine part are coordinating together in position, velocity and acceleration over the entire extraction path. The motion planner sends this data to the axis controller 26, which moves the robot along the planned trajectory. The trajectory for the movable machine part is used for determining an expected position for the machine part.

The machine is continually sending actual machine position/speed information Mₚₒₛ to the robot controller. The robot controller 3 is provided with a position check unit 28, which receives the position/speed information from the machine. If information on the speed is received, the actual position is calculated based on the speed information. The position check unit 28 is adapted to compare the position of the machine determined by the motion planner 24 with the actual position Mₚₒₛ received from the sensor 12 of the machine. During the motion, the position check unit 28 compares the calculated expected position of the machine part along the planned path that the robot is coordinated towards, to the actual position of the machine part, and generates a signal S to slow down or stop the motion of the machine part when the actual position is ahead of the expected position of the machine part. Optionally, the position check unit 28 can also be adapted to generate a signal A to start or speed up the motion of the machine part when the actual position of the machine part is behind the calculated expected position of the machine part.

The position of the machine part can also be interpreted as a distance along the path, where the path of the machine is linear from start (0%) to finish (100%). Similarly, the robot moves from start (0%) to finish (100%). The position check unit can then alternatively be converted into a check for distance along the path and is an equivalent check for a linear molding machine. If the machine to be tended has a curved motion, or a multi-axis motion, then the same process can be applied.

If the machine does not have a position signal but a speed signal, then only two target points need to be programmed, one point including the position of the robot and the machine part when the machine is opened, and the other point including the position of the robot and the machine part when the machine is closed. During the execution, the position check unit integrates the speed signal to estimate the actual position of the machine and the distance along the path is calculated.

When the motion planner receives the target points from the program executor, the motion planner plans the robot path. The distance between the points is divided into small increments. For each increment the motion planner calculates the position of each robot axis, and the position of the machine. For each increment, the motion planner determines which one of the robot axes is limiting, if the machine has no performance limitations.

For example, the robot shall move from a target point 1 (0 degrees) to a point 2 (90 degrees) at the same time as the machine is moving from an opened position (100 mm) to a closed position (0 mm). The target points are contained in a robot control program. The motion planner divides the motion between the target points into small increments, for example 100 increments, each increment taking 10 ms. For the first increment, the movement of the robot axis becomes 0.09 degrees, the movement of the machine part becomes 1 mm, and the robot and the machine shall carry out this movement within 10 ms. Thereafter, the motion planner determines whether all axes actually can move to the next position within 10 ms. The motion planner checks the performance data of the robot, and if it judges that the robot can not move so quickly, the path planner also checks the performance of the machine, but the performance of the machine is not limited and accordingly it is only the performance of the robot that limits the movement of the robot. Based on this information, the robot planner will adjust the movement of the first increment so that the robot, for example, moves 0.045 degrees during the 10 ms, which is only half the increment, and accordingly the machine must also move only half of the increment, i.e. 0.5 mm.

Thereafter, the planned machine increment (0.5 mm) is compared with the actual position received from the machine. If the machine has moved 0.1 mm, it is no problem since the machine is behind the planned machine path. However, if the machine has actually moved to 0.6 mm, it will collide with the robot which has not moved fast enough. In that case a signal is sent to the machine instructing it to slow down or stop.

The robot controller 3 further comprises a position check unit 28 adapted to compare the position of the machine determined by the motion planner 24 with the actual position Mₚₒₛ received from the sensor 12 of the machine. The position check unit 28 compares the actual position with an expected position of the machine part and generates a signal S to slow down or stop the motion of the machine part when the actual position is ahead of the expected position of the machine part. Optionally, the position check unit 28 can also be adapted to generate a signal to speed up the motion of the machine part A when the actual position of the machine part is behind the expected position of the machine part.

During the motion, the position check unit compares the expected position of the machine part along the planned path that the robot is coordinated towards, to the actual machine part position. If the position of the machine part is greater than the position of the calculated expected position, a signal to slow down or stop is sent to the machine. When the calculated position of the machine part along the planned path is ahead of the actual machine part, a signal A is sent to the machine to start or speed up.

The position of the machine part can also be interpreted as a distance along the path, where the path of the machine is linear from start (0%) to finish (100%). Similarly, the robot moves from start (0%) to finish (100%). The position check unit can then alternatively be converted into a check for distance along the path and is an equivalent check for a linear molding machine. If the machine to be tended has a curved motion, or a multi-axis motion, then the same process can be applied.

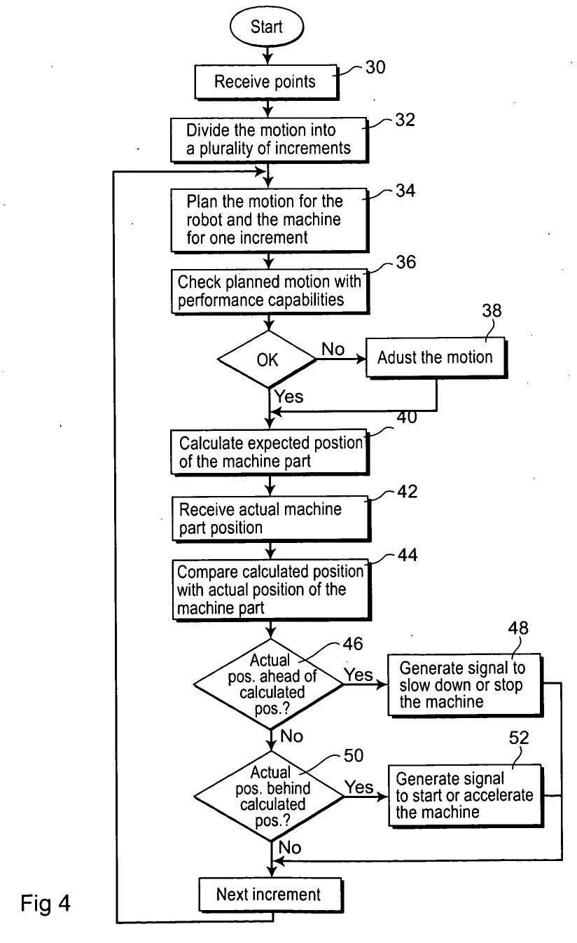

FIG. 4 is a flow diagram illustrating the method and the computer program product according to an embodiment of the present invention. It will be understood that each block of the flow diagram can be implemented by computer program instructions.

The motion planner receives target points including positions for the axes of the robot and positions of the machine part from the program executor, block 30. The motion between two received target points is divided into a plurality of small increments, block 32. The motions of the machine and the robot are planned for each increment, block 34. The planned motion for the robot is compared with performance capability data for the robot, block 36. If the robot is not able to perform the planned motion according to limitations in the performance of the robot, the motion is adjusted, block 38. A corresponding adjustment is made to the planned machine motion.

When the motions of the robot and the machine part have been planned, the expected position of the machine part after the machine part has moved the increment, is calculated based on the planned motion of the machine part, block 40. The actual position of the machine part is continuously received from the machine, block 42. The calculated expected position of the machine part is compared with the actual position of the machine part, block 44. If the actual position of the machine part is ahead of the calculated position, i.e. if the actual position is greater than the calculated position of the machine part, block 46, a signal to slow down or stop the machine is generated and sent to the machine, block 48. If the actual position of the machine part is behind the calculated expected position of the machine part, i.e. if the actual position is less than the calculated position of the machine part, block 50, a signal to start or accelerate the machine is generated and sent to the machine, block 52. The steps 34-52 are repeated for each increment until the motions between the two points have been carried out. Thereafter the same procedure is repeated for each target point received from the program executor.

The present invention is not limited to the embodiments disclosed but may be varied and modified within the scope of the following claims. For example, an external computer, such as the machine controller, may carry out at least some of the steps of the method. In an alternative embodiment, the programmed positions of the machine part can be stored in a separate memory and the path planner fetches the positions from the memory. The present invention is also applicable to a machine that has several axes that are closing or ejecting. In addition, the entire program for the robot and machine part can be generated off-line and then loaded to the controller.

1. An industrial robot for tending a machine including a machine part providing a repetitive sequence of movements, the robot including a robot controller comprising a program storage for storing a path of programmed positions for the robot and a path of programmed positions for the machine part, and a motion planner configured to plan the motion of the robot and the motion of the machine part based on the programmed positions for the robot and the machine part such that the motion of the robot and the motion of the machine part are coordinated with each other, characterized in that the motion planner is configured to calculate expected positions of the machine part along the path based on the planned motion of the machine part, and the robot controller is configured to receive information on actual positions of the machine part, to compare the actual positions with the expected positions of the machine part, and to generate a signal to slow down or stop the motion of the machine part when the actual position is ahead of the expected position of the machine part.

2. The industrial robot according to claim 1, wherein the motion planner is configured to plan the motion of the robot and the motion of the machine part based on performance capabilities of the robot and of the machine, and the performance capabilities for the machine are set to be much higher than for the robot so that the motion planner uses the limitations of the robot when planning the motion of the machine.

3. The industrial robot according to claim 1, wherein the robot controller further is configured to generate a signal to speed up the motion of the machine part when the actual position of the machine part is behind the expected position of the machine part.

4. The industrial robot according to claim 1, wherein the motion planner is configured to plan the motion of the robot and the machine part in incremental steps, and to calculate the expected position of the machine part for each incremental step, and the robot controller is configured, for each incremental step, to compare the actual position of the machine part with the expected position.

5. The industrial robot according to claim 1, wherein the path planner is configured to generate set point values for the robot motion and set point values for the expected motion of the machine part and the set point values of the machine part contains the expected position of the machine part.

6. The industrial robot according to claim 1, wherein at least two of said programmed positions for the robot correspond in time to at least two of said programmed positions for the machine part.

7. The industrial robot according to claim 6, wherein said program storage is configured to store a control program including movement instructions for the robot and the machine part and the control program includes a plurality of positions on the robot path and a plurality of corresponding positions on the machine part path, and the robot controller further comprises a program executor adapted, during execution of the control program, to extract said corresponding positions on the robot path and the machine path, and to send the positions to the motion planner.

8. The industrial robot according to claim 1, wherein the robot is configured to extract a part from the machine when the movement of the machine part is closing the machine.

9. A method for controlling an industrial robot tending a machine including a machine part providing a repetitive sequence of movements, the method comprising:
storing a path of programmed positions for the robot and a path of programmed positions for the machine part,
planning the motion of the robot and the motion of the machine part based on the programmed positions for the robot and the machine part such that the motion of the robot and the motion of the machine part are coordinated with each other, characterized in that the method further comprises repeatedly:
calculating an expected position for the machine part based on the planned motion of the machine part,
receiving information on the actual position of the machine part,
comparing the actual position of the machine part with the expected position, and
generating a signal to slow down or stop the motion of the machine part if the actual position is ahead of the expected position of the machine part.

10. The industrial robot according to claim 1, wherein the motion planner is configured to plan the motion of the robot and the motion of the machine part based on performance capabilities of the robot and of the machine, and the performance capabilities for the machine are set to be much higher than for the robot so that the motion planner uses the limitations of the robot when planning the motion of the machine.

11. The method according to claim 10, wherein the method further comprises generating a signal to speed up the motion of the machine part when the actual position of the machine part is behind the expected position of the machine part.

12. The method according to claim 10, wherein the motion of the robot and the motion of the machine part is planned in incremental steps, and the expected position of the machine part is calculated for each incremental step, and the actual position of the machine part is compared with the expected position and said signal is generated for each incremental step.

13. The method according to claim 10, wherein the method comprises generating set point values for the robot motion and set point values for the expected motion of the machine part and the set point values of the machine part contain the expected position of the machine part.

14. The method according to claim 10, wherein at least two of said programmed positions for the robot correspond in time to at least two of said programmed positions for the machine part.

15. The method according to claim 10, wherein said tending of the machine includes the robot extracting a part from the machine when the movement of the machine part is closing the machine.

16. The method according to claim 10, wherein the method comprises recording a typical motion of the machine part and creating the programmed positions for the machine part based on the recorded motion.

17. The method according to claim 10, wherein the method comprises creating the program for the robot and machine part off-line.

18. A computer program product directly loadable into the internal memory of a robot controller, comprising software for performing the steps of claim 10.

19. A computer-readable medium, having a program recorded thereon, where the program is to make a robot controller perform the steps of claim 10, when said program is run on the robot controller.
